(19) United States
(12) Patent Application Publication
(10) Pub. No.: US 2016/0156090 A1
(43) Pub. Date: Jun. 2, 2016

(54) Flat optics enabled by dielectric metamaterials

(71) Applicant: Sandia Corporation, Albuquerque, NM (US)

(72) Inventors: Salvatore Campione, Albuquerque, NM (US); Michael B. Sinclair, Albuquerque, NM (US); Lorena I. Basilio, Albuquerque, NM (US); Larry K. Warne, Albuquerque, NM (US)

(21) Appl. No.: 15/003,361

(22) Filed: Jan. 21, 2016

Related U.S. Application Data
(63) Continuation-in-part of application No. 13/618,997, filed on Sep. 14, 2012.
(60) Provisional application No. 61/622,870, filed on Apr. 11, 2012.
(60) Provisional application No. 61/536,937, filed on Sep. 20, 2011.

(51) Int. Cl. H01P 7/10

(52) U.S. Cl. CPC H01P 7/10

(57) ABSTRACT

Metasurfaces comprise a two-dimensional periodic array of single-resonator unit cells. Single or multiple dielectric gaps can be introduced into the resonator geometry in a manner suggested by perturbation theory, thereby enabling overlap of the electric and magnetic dipole resonances and directional scattering by satisfying the first Kerker condition. The geometries suggested by perturbation theory can achieve purely dipole resonances for metamaterial applications such as wave-front manipulation with Huygens' metasurfaces.

### CROSS-REFERENCE TO RELATED APPLICATION

This application is a continuation-in-part of U.S. application Ser. No. 13/618,997, filed Sep. 14, 2012, which claims the benefit of U.S. Provisional Application No. 61/536,937, filed Sep. 20, 2011, and U.S. Provisional Application No. 61/622,870, filed Apr. 11, 2012, each of which is incorporated herein by reference.

### STATEMENT OF GOVERNMENT INTEREST

This invention was made with Government support under contract no. DE-AC04-94AL85000 awarded by the U. S. Department of Energy to Sandia Corporation. The Government has certain rights in the invention.

### FIELD OF THE INVENTION

The present invention relates to metamaterials and, in particular, to flat optics enabled by dielectric metamaterials.

### BACKGROUND OF THE INVENTION

Metallic resonators exhibit high intrinsic ohmic losses that preclude their use in resonant metamaterials operating at infrared and higher frequencies. Dielectric resonators represent a promising alternative building block for the development of low-loss resonant metamaterials because they replace lossy ohmic currents with low-loss displacement currents. See A. Ahmadi and H. Mosallaei, Phys. Rev. B 77(4), 045104 (2008). The spectral locations of electric and magnetic dipole resonances of a dielectric resonator can be tuned by varying the resonator geometry so that desired scattering properties are achieved. For example, by appropriately overlapping electric and magnetic dipole resonances, cancellation of scattering in the backward or forward direction can be achieved as dictated by the Kerker conditions. In particular, a resonator with these properties exhibits equal electric and magnetic dipole coefficients that destructively interfere in the backward propagating direction (first Kerker condition). See M. Kerker et al., J. Opt. Soc. Am. 73(6), 765 (1983); J. M. Geffrin et al., Nat Commun 3, 1171 (2012); and Y. H. Fu et al., Nat Commun 4, 1527 (2013). Assembling the resonators into two-dimensional periodic arrays may lead to similar behavior (i.e., minima in reflection or transmission). See I. Staude et al., ACS Nano 7(9), 7832 (2013).

However, the use of dielectric resonators is not without its own challenges since achieving the desired resonant properties while maintaining a sufficiently small resonator size and spacing requires the use of very high permittivity materials. While permittivity values larger than 100 are readily available at THz and microwave frequencies, the largest permittivity currently available at infrared wavelengths is approximately 32 (e.g. lead telluride). Thus, the geometric details of the dielectric resonator design and their assembly into metamaterials are extremely constrained, and maintaining effective medium behavior is challenging. For this reason, the field of metamaterials has focused in recent years in the development of homogeneous artificial materials that are characterized by local effective material parameters. See R. E. Collin, Field Theory of Guided Waves (McGraw Hill, 1960); M. G. Silveirinha, Phys. Rev. B 76(24), 245117 (2007); C. R. Simovski, Opt. Spectrosc. 107(5), 726 (2009); A. Alù, Phys. Rev. B 83(8), 081102 (2011); R. Shore and A. D. Yaghjian, Radio Sci. 47, RS2014 (2012); J. C. Ginn et al., Phys. Rev. Lett. 108(9), 097402 (2012); H. Alaeian and J. A. Dionne, Opt. Express 20(14), 15781 (2012); and S. Campione et al., Phot. Nano. Fund. Appl. 11(4), 423 (2013). A necessary condition for local behavior is that the metamaterial constituents possess only dominant (electric and/or magnetic) dipole resonances and negligible higher-order multipolar terms (e.g. quadrupoles, octupoles, etc.). This fact was very recently emphasized by Menzel et al. where the authors achieved local magnetic metamaterials through the use of the extreme coupling regime of cut-plate pairs or split ring resonators. See C. Menzel et al., Phys. Rev. B 89(15), 155125 (2014).

### SUMMARY OF THE INVENTION

The present invention is directed to a metasurface comprising a two-dimensional periodic array of single-resonator unit cells, each resonator comprising at least one inclusion in a dielectric structure wherein the at least one inclusion has a different permittivity than the dielectric structure material and wherein the electric dipole resonance and the magnetic dipole resonance of the resonator satisfy the first Kerker condition. For example, the dielectric structure can comprise a cubic, cylindrical, rectangular, or spherical structure of a high permittivity material, such as Si, GaAs, Ge, PbTe, Te, or ZrₓSn₁₋ₓTiO₄. The at least one inclusion can comprise a low-permittivity inclusion, such as an air split, gas-filled gap, vacuum gap, or a dielectric foam, thereby shifting the lower frequency magnetic dipole resonance toward the higher frequency electric dipole resonance. The low-permittivity inclusion can be oriented perpendicular to the electric field associated with the first magnetic mode. Alternatively, the at least one inclusion can comprise a metallic dipole, thereby shifting the higher frequency electric dipole resonance toward the lower frequency magnetic dipole resonance. Alternatively, the at least one inclusion can comprise at least one high-permittivity inclusion, thereby shifting the higher frequency electric dipole resonance to a lower frequency, and at least one low-permittivity inclusion, thereby shifting the lower frequency magnetic dipole resonance to a higher frequency.

By tailoring the design of the dielectric resonators, low-loss metamaterials at microwave, THz, visible and infrared frequencies can be realized. The far-field scattered by subwavelength resonators can be decomposed in terms of multipolar field components, providing explicit expressions for the multipolar far-fields. For example, an isolated high-permittivity dielectric cube resonator possesses frequency separated electric and magnetic dipole resonances, as well as a magnetic quadrupole resonance in close proximity to the electric dipole resonance. For example, single or multiple dielectric gaps can be introduced into the resonator geometry in a manner suggested by perturbation theory, thereby enabling overlap of the electric and magnetic dipole resonances and directional scattering by satisfying the first Kerker condition. The quadrupole resonance can be pushed away from the degenerate dipole resonances to achieve local behavior. The geometries suggested by perturbation theory can achieve purely dipole resonances for metamaterial applications such as wave-front manipulation with Huygens' metasurfaces.

### BRIEF DESCRIPTION OF THE DRAWINGS

The detailed description will refer to the following drawings, wherein like elements are referred to by like numbers.

FIG. 1 is a graph illustrating resonance shifting due to various perturbation treatments. A split or cutout along the center of a dielectric resonator (e.g., a dielectric cube or sphere) can be introduced to upshift (in frequency) the magnetic resonance towards the higher frequency electric resonance. In order to realize a frequency downshift in the electric resonance (towards the magnetic resonance), a metallic dipole can be embedded within the dielectric resonator.

FIG. 2 shows a subwavelength resonator under plane wave illumination scattering a far field that can be decomposed in terms of multipolar field components, i.e. dipole, quadrupole, and higher order terms.

FIG. 3(a) illustrates the E- field drive condition. FIG. 3(b) illustrates the H-field drive condition. The phases of the counter propagating plane waves are chosen to cancel either the magnetic field (for E-field drive) or the electric field (for H-field drive) at the center of the resonator.

FIG. 4(a) is a graph of the radiated far-field amplitudes. FIG. 4(b) is a graph of the power associated with the multipoles m_{MD}^{y}, p_{ED}^{x}, and Q_{MQ}^{zy} of a cubic dielectric resonator. Sampling positions are located on the θ=90° plane at φ=90° for E-field drive (squares) and at φ=0° for H-field drive (triangles). The inset shows a schematic of the geometry including the sampling points depicted by crosses.

FIGS. 5(a)-(f) are graphs of the far-field patterns versus θ and φ for a cubic dielectric resonator at the magnetic dipole resonance, electric dipole resonance, and magnetic quadrupole resonance, computed via full-wave simulations (FIGS. 5(a), 5(c), and 5(e) and reproduced via multipolar expansion (FIGS. 5(b), 5(d), and 5(f)).

FIG. 6 shows the angular distribution in the y-z and x-z planes of the far-field scattered by a cubic dielectric resonator at the magnetic dipole resonance (solid), electric dipole resonance (dashed), and magnetic quadrupole resonance (dotted).

FIG. 7(a) shows the radiated far-field amplitudes of single-split cubes with gap of 100 nm. FIG. 7(b) shows the radiated far-field amplitudes of single-split cubes with gap of 200 nm. Sampling positions are located on the θ=90° plane at φ=90° for E-field drive (squares) and at φ=0° for H-field drive (triangles). The insets show schematics of the two geometries.

FIGS. 8(a)-(c) are graphs showing the relative location of electric (squares) and magnetic (triangles) polarizabilities of subwavelength resonators is controllable through geometry. Solid: Real part; dashed: imaginary part. FIG. 8(a) is a graph for the full-cube. FIG. 8(b) is a graph for the single-split cube with gap s=100 nm. FIG. 8(c) is a graph for the single-split cube with gap s=200 nm and d=1.53 μm. The monochromatic time harmonic convention, exp(−iωt) , is assumed.

FIG. 9(a) is a graph of the polarizability result shown in FIG. 8(c). The frequencies that satisfy the first Kerker condition are indicated by the dashed-dotted vertical lines. FIG. 9(b) is a graph of the scattered radiation pattern of an isolated single-split dielectric cube resonator excited through plane wave incidence for three excitation frequencies: forward scattering is evident (i.e. only one lobe at θ=180 degrees) when the first Kerker condition is satisfied. Only data between 0 and 180 degrees is reported; the scattering is specular between 180 and 360 degrees.

FIG. 10 is a schematic illustration of a metasurface comprising a two-dimensional array of split-cube resonators arranged on a square lattice.

FIG. 11(a) is a graph of the reflectance and FIG. 11(b) is a graph of the transmittance of a two-dimensional array of dielectric resonators [full cubes as in FIG. 8(a) and single-split cubes as in FIG. 8(c)] arrayed on a square lattice with a period of 2.6 μm. FIG. 11(c) is a graph of the phase of the reflection coefficient and FIG. 11(d) is a graph of the phase of the transmission coefficient for the cases in FIGS. 11(a)-(b).

FIG. 12 is a graph of the radiated far-field amplitudes of a four-split cube as in the inset. Sampling positions are located on the θ=90° plane at φ=90° for E-field drive (squares) and at φ=0° for H-field drive (triangles).

FIG. 13(a) is a graph of the radiated far-field amplitudes (|E₀|) of the three resonator designs analyzed. Sampling positions are located on the φ=90° plane at φ=90° for E-field drive. FIG. 13(b) is a graph of the quadrupolar resonance shift in Eq. (10) versus the three resonator designs analyzed.

### DETAILED DESCRIPTION OF THE INVENTION

The invention makes use of geometries based on perturbation theory, previously introduced in Warne et al., as an alternative route to obtain resonators that exhibit dominant dipole resonances in certain frequency bands. See U.S. application Ser. No. 13/618,997 to Warne et al., filed Sep. 14, 2012, which is incorporated herein by reference. These perturbed resonators can be used to achieve local properties in metamaterials. Such perturbations of the resonator geometry provide additional degrees of freedom that allow the overlap of the electric and magnetic dipole resonances, enabling negative-index- or zero-index-like functionalities. Warne et al. uses cavity-perturbation techniques to determine the types of inclusions (in terms of material, polarization, and placement) that are necessary to realize degenerate dipole resonances, and provides simple formulas which can be used for the design of these types of resonators. The present invention uses such perturbed resonators for a directional scattering metamaterial application.

According to the techniques of Warne et al., high- and low-permittivity inclusions are placed within a resonator volume to perturb the resonant frequencies into alignment. It is useful to select polarization-dependent perturbations of high contrast relative to the resonator dielectric material so that one of the modes is selected (by virtue of the associated electric-field orientation) to move the respective resonant frequency in the appropriate direction (ultimately bringing the two modes together).

For example, low-permittivity inclusions can be conveniently realized by a cut oriented perpendicular to electric field lines associated with the lowest magnetic mode (and ideally having no normal electric field from the first electric mode). The cut can be a vacuum gap, an air split, or a gap filled with other gas, dielectric foam, or other low-loss, low-permittivity materials. Alternatively, the inclusion can be thin and have a pancake shape, such as an oblate spheroid. Preferably, the inclusion has a relative permittivity near one with no loss. With these types of perturbations, the magnetic dipole mode is shifted upward in frequency (downward in wavelength) toward the electric dipole mode. However, the amount of the frequency shift will eventually saturate as the size of the cut is increased. This effect can be overcome by using multiple inclusions within the dielectric resonator.

Alternatively, high-permittivity inclusions can be realized with metallic dipoles which are oriented along electric field lines associated with the first excited electric mode (and ideally at a null of the electric field of the first magnetic mode), in order to shift the electric resonance downward in frequency (upward in wavelength) toward the magnetic dipole mode. The metallic dipole preferably comprises a low-loss metal and has an elongated shape, such as a rod or prolate spheroid, that selectively shifts the electric resonance but leaves the magnetic resonance unperturbed. More dipoles at other orientations can be added to provide a more isotropic response.

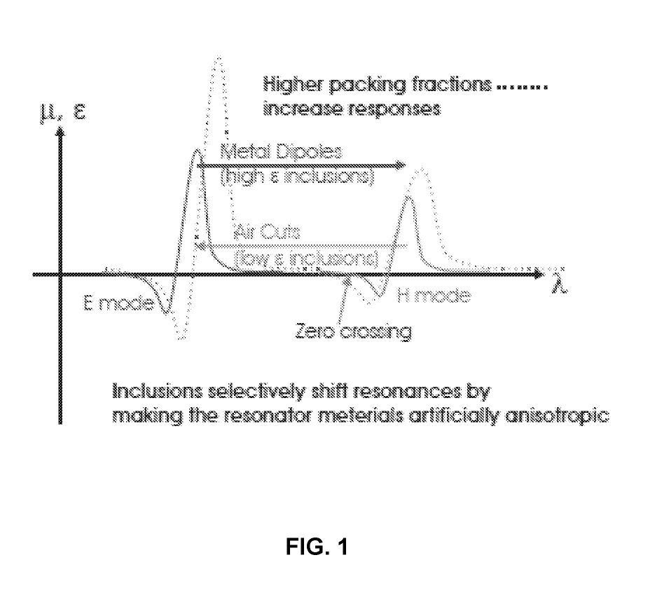

The effects resulting from air cuts and metal dipoles on the dielectric resonator performance are summarized in FIG. 1. It is important to point out that, depending on the frequency range of interest, each of these designs offer different advantages in terms of ease of manufacturing, losses, and electrical size. For example, at microwave frequencies a dielectric resonator with a metallic dipole insert may be fairly easy to realize, without a significant deterioration in the loss performance. The reasonable maintenance of the loss performance, together with the fact that the electric size of the resonator becomes smaller as the electric dipole mode is downshifted to lower frequencies (ultimately overlapping the magnetic resonance for negative-index performance), are clear advantages of this type of design. On the other hand, as the frequency is increased (i.e., the wavelength is decreased), air inclusions may become a more attractive option.

A common way to identify the multipoles that dominate the scattering response of isolated resonators is through the use of multipolar analysis or multipolar expansion. See C. Menzel et al., Phys. Rev. B 89(15), 155125 (2014). C. F. Bohren and D. R. Huffman, Absorption and Scattering of Light by Small Particle (John Wiley & Sons, Inc., 1983); J. D. Jackson, Classical Electrodynamics (Wiley, 1999); C. H. Papas, Theory of Electromagnetic Wave Propagation (Dover Publications, Inc., 1995); P. Grahn et al., New J. Phys. 14(9), 093033 (2012); A. B. Evlyukhin et al., J. Opt. Soc. Am. B 30(10), 2589 (2013); J. Chen et al., Nat. Photonics 5(9), 531 (2011); and S. Mühlig et al., Metamaterials (Amst.) 5(2-3), 64 (2011). According to Bohren and Huffman, the scattered field Eₛ produced by a sphere can in general be written as an infinite series in the vector spherical harmonics Nₑₘₙ and Mₒₘₙ (where the subscripts e and o stand for even and odd, respectively), the so-called electromagnetic normal modes of the spherical particle, weighted by appropriate coefficients aₘₙ and bₘₙ as

$${E}_{s} = {\sum }_{n = 1}^{∞} {\sum }_{m = - n}^{n} ( {a}_{mn} {N}_{emn} + {b}_{mn} {M}_{omn} ) \qquad ( 1 )$$

In Eq. (1), the index n indicates the degree of the multipole (e.g. 1=dipole, 2=quadrupole, 3=octupole, etc.) and m indicates the possible orientations of the multipole. Eq. (1) can be extended to model the scattered field produced by subwavelength resonators of any shape through suitable choice of the aₘₙ and bₘₙ coefficients. Although this is probably the most common multipolar expansion formulation due to its compactness and elegance, it is preferable to express the multipolar components in terms of the multipole moments, e.g. p , m, and Q (their definitions are provided below). This will give a better insight on the far-field angular dependence otherwise hidden in the terms reported in Eq. (1).

Explicit expressions for the multipole fields in terms of the multipole moments can describe how the field scattered by an arbitrary (subwavelength) object can be decomposed into a sum of multipole fields. This formulation is applied below to the case of a high-permittivity dielectric resonator that supports electric and magnetic dipole resonances in separate frequency bands, as well as a quadrupolar resonance, and it is shown that the formulation clearly identifies the contribution of each multipole. The resonator geometry is then modified in a manner suggested by perturbation theory in order to overlap the electric and magnetic dipole resonances, while simultaneously pushing away the quadrupolar resonance and thereby enabling local behavior at the dipole resonances. The electric and magnetic dipole polarizabilities of the perturbed resonators are also computed, and the first Kerker condition is shown to be satisfied to obtain forward scattering behavior. A metamaterial array of perturbed cubic resonators is shown to exhibit high transmission and 2π phase coverage—the characteristic properties required for high efficiency Huygens' metasurfaces. See M. Decker et al., “High efficiency light-wave control with all-dielectric optical Huygens' metasurfaces,” arXiv:1405.5038 (2014); and C. Pfeiffer and A. Grbic, Phys. Rev. Lett. 110(19), 197401 (2013). Additional degrees of freedom afforded by the perturbation approach allows the design of resonators that are appealing for metamaterial applications. See C. Pfeiffer and A. Grbic, Phys. Rev. Lett. 110(19), 197401 (2013); and F. Monticone et al., Phys. Rev. Lett. 110(20), 203903 (2013).

### Theoretical Framework of Multipolar Expansion

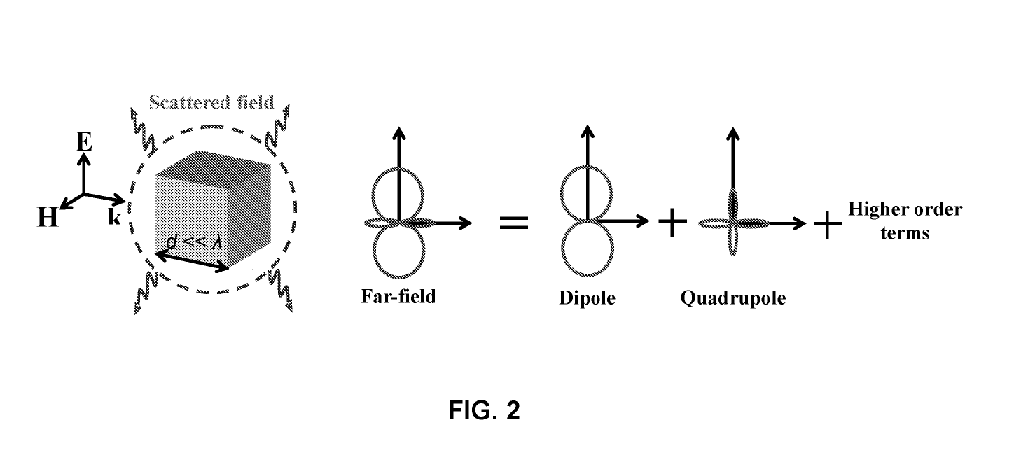

Consider the total far field Eₜₒₜ scattered by a subwavelength resonator illuminated by a plane wave. As indicated by Eq. (1) and shown in FIG. 2, the total far field can be decomposed in terms of multipolar components as

Eₜₒₜ=EE_{ED}+E_{MD}+E_{EQ}+E_{MQ}+E_{EO}+E_{MO}+higher order terms, (2)

where the subscripts on the right hand side indicate electric and magnetic dipoles (ED and MD), electric and magnetic quadrupoles (EQ and MQ), and electric and magnetic octupoles (EO and MO). See J. D. Jackson, Classical Electrodynamics (Wiley, 1999). The list in Eq. (2) has been truncated purposely to the octupolar terms; higher order terms are present, though they are negligible in most of the cases where the size of the scattering object is small compared to the wavelength. See C. F. Bohren and D. R. Huffman, Absorption and Scattering of Light by Small Particles (John Wiley & Sons, Inc., 1983).

The contributions of the multipole components in Eq. (2) can be written in vectorial form as

$$\begin{matrix}{E}_{ED} = {Z}_{0} \frac{{ck}^{2}}{4 π} \frac{{e}^{i kr}}{r} \hat{r} \times p \times \hat{r} , {E}_{MD} = - {Z}_{0} \frac{{k}^{2}}{4 π} \frac{{e}^{i kr}}{r} \hat{r} \times m , & ( 3 ) \\ {E}_{EQ} = - {Z}_{0} \frac{{ick}^{3}}{24 π} \frac{{e}^{i kr}}{r} \hat{r} \times {Q}_{EQ} \times \hat{r} , {E}_{MQ} = {Z}_{0} \frac{{ik}^{2}}{24 π} \frac{{e}^{i kr}}{r} \hat{r} \times {Q}_{MQ} , & ( 4 ) \\ {E}_{EO} = - {Z}_{0} \frac{{ck}^{4}}{120 π} \frac{{e}^{i kr}}{r} \hat{r} \times {Q}_{EO} \times \hat{r} , {E}_{MO} = {Z}_{0} \frac{{k}^{4}}{120 π} \frac{{e}^{i kr}}{r} \hat{r} \times {O}_{MO} , & ( 5 )\end{matrix}$$

where \hat{r}=sin θ cos φ\hat{x}+sin θ sin φŷ+cos θ\hat{z} is the unit vector in the radial direction, Z₀ is the free-space wave impedance, c is the speed of light, and k=ω/c is the free-space wavenumber, with ω the angular frequency. Moreover, p[Cm] is the electric dipole moment, m[Am²] is the magnetic dipole moment, Q_{EQ}[Cm²]=Q_{EQ}·\hat{r} is the electric quadrupole moment, Q_{MQ}[Am³]=Q_{MQ}·\hat{r} is the magnetic quadrupole moment, O_{EO}[Cm³]=(O_{EO}·\hat{r})·\hat{r} is the electric octupole moment, and O_{MO}[Am⁴]=(O_{MO}·\hat{r})·\hat{r} is the magnetic octupole moment. Note that the terms Q_{EQ} and Q_{MQ} are symmetric tensors and traceless, i.e. Q^{xx}+Q^{yy}+Q^{zz}=0, reducing the independent quadrupolar components to five [in agreement with Eq. (1) where n=2, m=−2, −1, 0, +1, +2]. Similarly, O_{EO} and O_{MO} are symmetric tensors and traceless, i.e. ΣⱼO^{jji}=ΣⱼO^{jij}=ΣⱼO^{ijj}=0, reducing the independent octupolar components to seven [in agreement with Eq. (1) where n=3, m=−3, −2, −1, 0, +1, +2, +3].

In general, multipole (MP) far fields can be expressed as:

E_{MP}−W_{MP}C_{MP}A_{MP}(θ,φ) (6)

where W_{MP} is the (complex) weight of the multipole moment and C_{MP} is a radially dependent pre-factor [e.g. C_{MP}=Z₀2ck²e^{ikr}/(3r) for an electric dipole]. A_{MP}(θ,φ) are orthonormal angular functions. For example, A_{MP}(θ,φ)=(−sin φ\hat{φ}30 cos θ cos φ\hat{θ})/(8π/3) for an x-directed electric dipole. The orthonormality of these angular functions over the solid angle can be exploited to extract the contribution of each multipole to the total scattered field:

$${W}_{MP} {C}_{MP} = {\int }_{0}^{2 π} {\int }_{0}^{π} [ {E}_{tot} \cdot {A}_{MP} ( θ , φ ) ] sin θ d θ d φ . \qquad ( 7 )$$

The total power associated with each multipole is then computed as

$${P}_{MP} = \frac{{\vert {W}_{MP} \vert}^{2} {\vert {C}_{MP} \vert}^{2}}{2 {Z}_{0}} . \qquad ( 8 )$$

The total radiated power can be used to determine which multipoles make significant contributions to the overall field scattered by the dielectric resonators.

### Multipolar Expansion for a Single Dielectric Cube Under Electric- and Magnetic-Field Drive Conditions

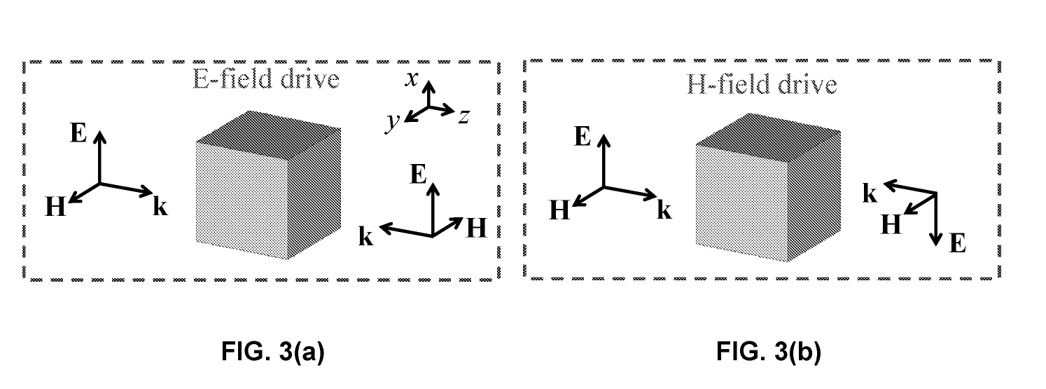

Consider electric- (E-) and magnetic- (H-) field drive conditions as shown in FIGS. 3(a)-(b). See L. I. Basilio et al., IEEE Antennas Wirel. Propag. Lett. 10, 1567 (2011); and C. Rockstuhl et al., Phys. Rev. B 83(24), 245119 (2011). These excitation schemes make use of two counter propagating plane waves to cancel either the magnetic field (for E-field drive) or the electric field (for H-field drive) at the center of the resonator. In this way, either electric or magnetic resonances can be selectively excited and their spectral locations located independently, provided the scattering object is sufficiently subwavelength.

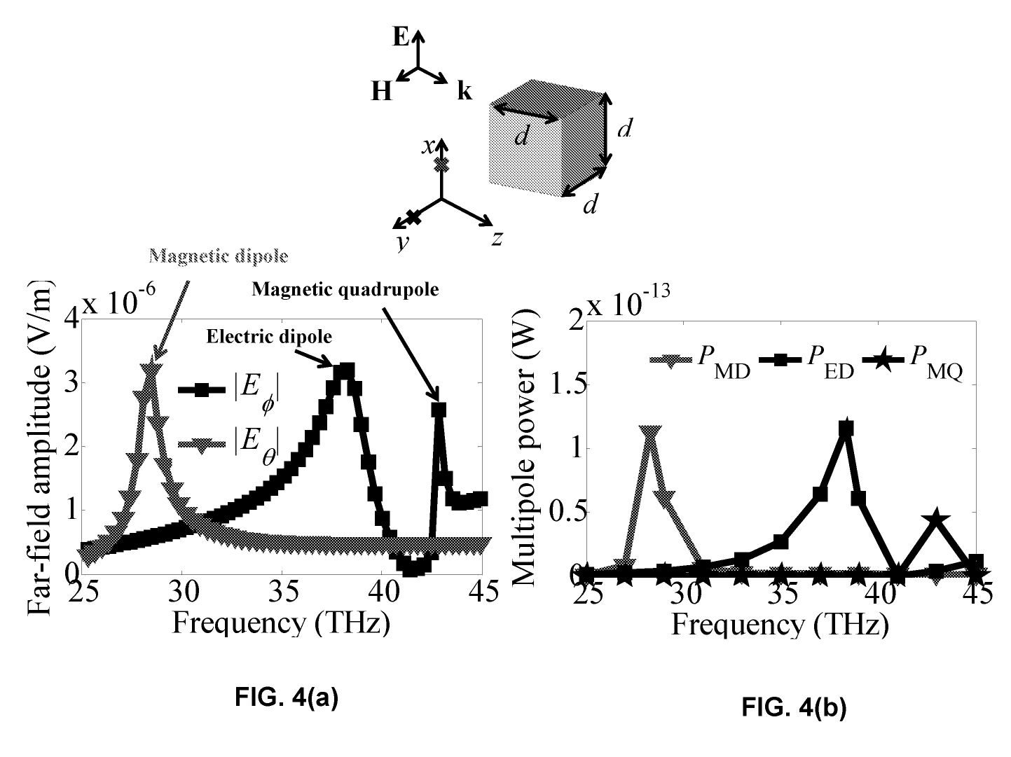

To demonstrate the utility of the multipole decomposition approach, the simple case of a lead telluride (PbTe) dielectric cube is analyzed with side d=1.53 μm (about 1/7th of the free-space wavelength at the magnetic resonance) and relative permittivity equal to 32.04+10.0566 embedded in free space. Although for simplicity resonators in free space are considered, placement of the resonators on a layer of low-index materials such as barium fluoride may require minor modifications to the design but will not significantly alter the properties. See S. Liu et al., Optica 1(4), 250 (2014). This resonator design leads to electric and magnetic resonances in the mid-infrared region of the spectrum. The scattered far field obtained from full-wave simulations is shown in FIG. 4(a) for two different sampling positions: 1) θ=90° and φ=90° for E-field drive; and 2) θ=90° and φ=0° for H-field drive.

In agreement with Warne et al., the magnetic dipole resonance at 28.31 THz (under H-field drive), the electric dipole resonance at 38.37 THz (under E-field drive), and the magnetic quadrupole resonance at 42.98 THz (under E-field drive) are observed. These resonances are explicitly marked in FIG. 4(a). Using the scattering cross sections in place of the radiated far-field amplitudes as for example done in Menzel et al. will lead to similar conclusions. To further validate the approach, the results of FIG. 4(a) are recalculated using the radiated powers of the three dominant multipoles (m_{MD}^{y}, p_{ED}^{x}, and Q_{MQ}^{zy}). The results are shown in FIG. 4(b), and very good agreement with FIG. 4(a) is observed.

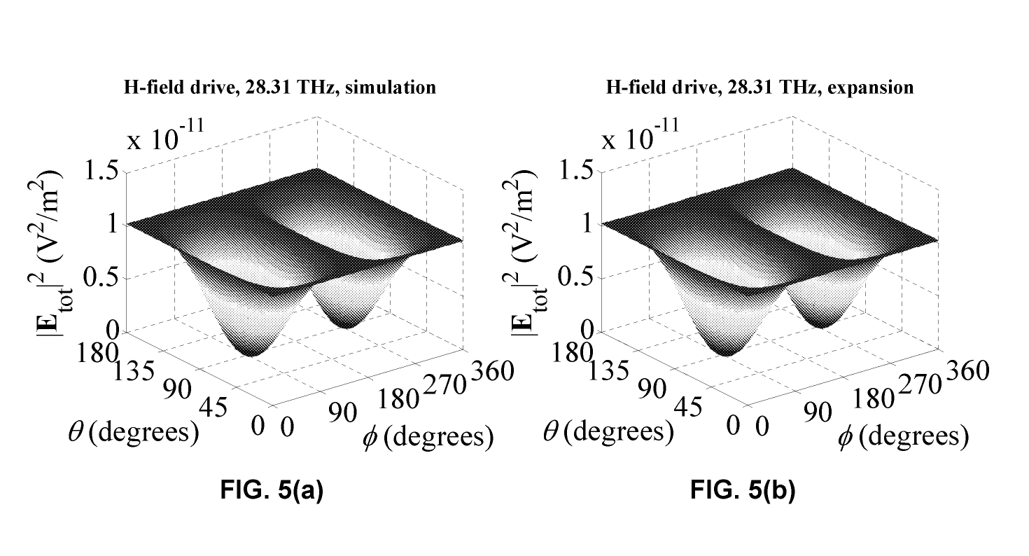

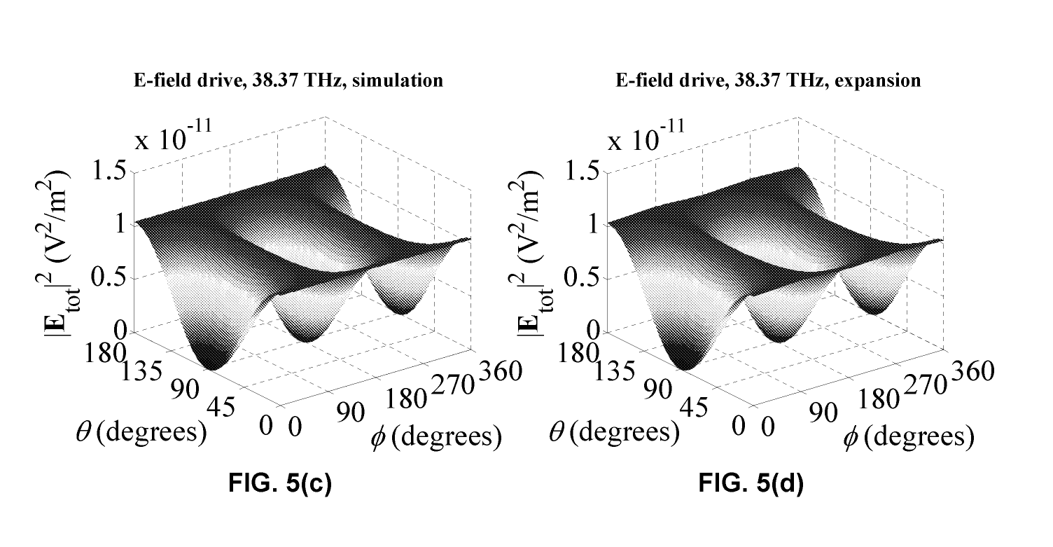

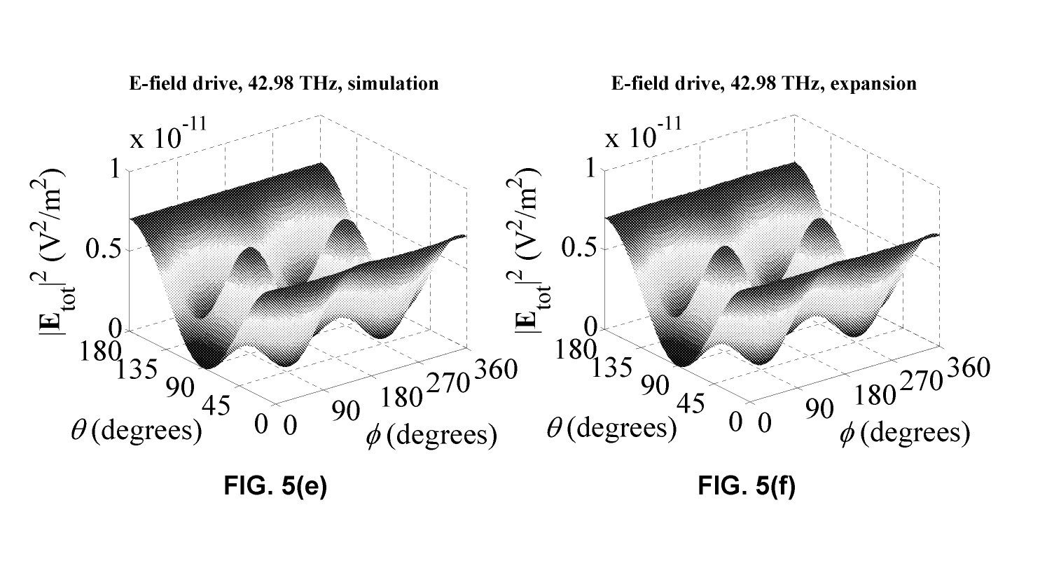

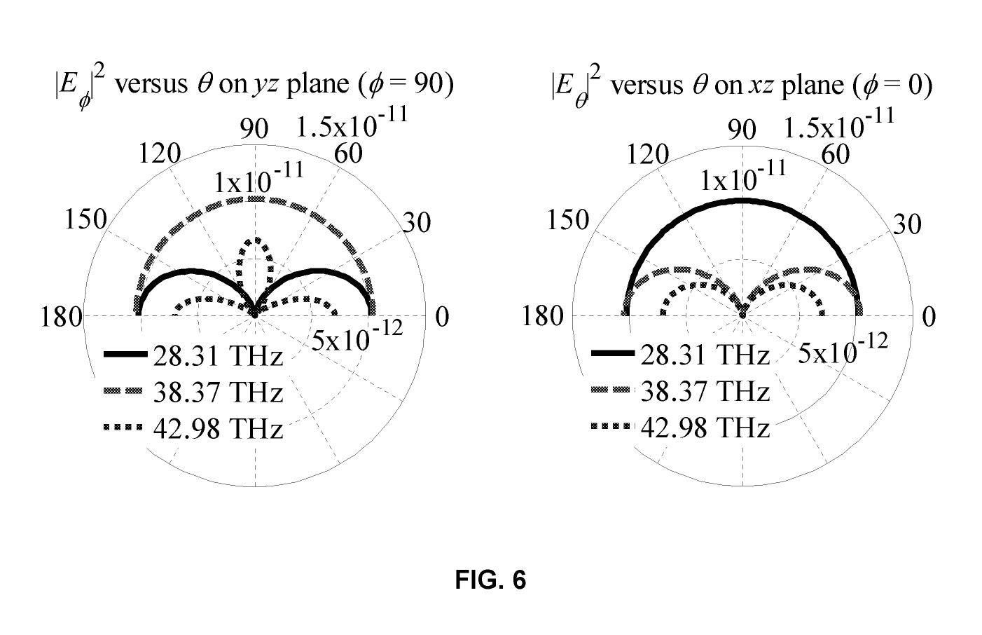

FIGS. 5(a)-(f) compare the angular dependences of the far-field patterns at the three resonant frequencies obtained using full-wave simulations under E- and H-field drives to the fields obtained using the multipolar expansion methodology. Note that the multipole decomposition recovers the spectral and angular characteristics to a high degree of accuracy (the phase information is also recovered, although it is not shown for brevity). Table 1 summarizes the power associated with the dominant multipoles at the three resonant frequencies. As expected, the electric dipole and the magnetic dipole moments dominate at the electric and magnetic dipole resonance frequencies, respectively. At the magnetic quadrupole frequency, a dominating magnetic quadrupole moment is found along with a small (but not negligible) contribution of an electric dipole moment. The scattered powers of the multipoles not listed in Table 1 are smaller by at least two orders of magnitude. The scattered E-field patterns sampled at the three resonant frequencies are plotted in FIG. 6, where clear signatures of dipolar and quadrupolar fields are observed.

TABLE 1
Power associated with each multipole for a subwavelength dielectric
cube.

| | Frequency (THz) | | |
|---|---|---|---|
| | 28.31 | 38.37 | 42.98 |
| Excitation scheme | H-field drive | E-field drive | E-field drive |
| Multipole | m_{MD}^{y} | p_{ED}^{x} | p_{ED}^{x}, Q_{MQ}^{zy} |
| Power (×10⁻¹³ W) | 1.13 | 1.16 | 0.04, 0.43 |

### Overlapping the Electric and Magnetic Dipole Resonances with a Single-Split Dielectric Cube

As described in Warne et al., perturbation techniques can be used to obtain resonator geometries that selectively adjust the spectral locations of the resonances. In particular, Warne et al. use split-cubes or split-spheres to overlap the electric and magnetic dipole resonances. The splits are arranged in such a manner as to selectively interact with the electric field pattern of the magnetic resonance and shift the resonance frequency upwards towards the electric resonance frequency.

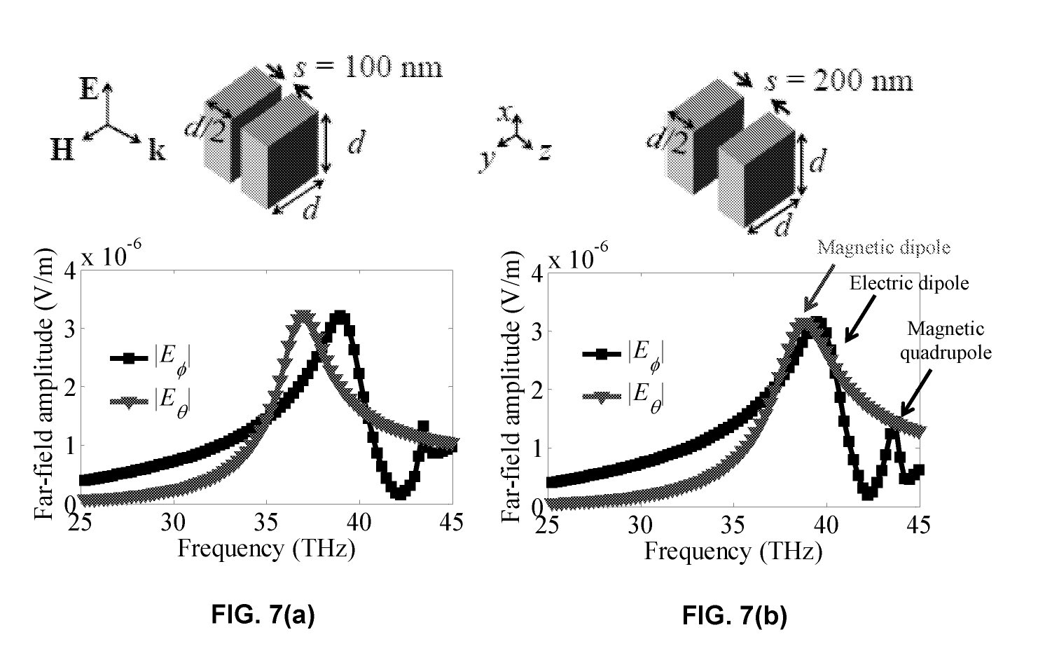

A dielectric cube containing a split in the midplane transverse to the plane wave propagation direction (creating a small gap between the two half cubes) is shown in the insets of FIGS. 7(a)-(b). Two values of the gap, namely 100 and 200 nm, are analyzed to show that the perturbation causes the magnetic dipole resonance to move towards the electric one. Full-wave simulations of the scattered field were performed. In FIGS. 7(a)-(b) are plotted the radiated far-field amplitudes at two different sampling positions: 1) θ=90° and φ=90° for E-field drive; 2) θ=90° and φ=0° for H-field drive. Under H-field drive, the magnetic dipole resonance at 36.97 and 38.97 THz are observed for 100 and 200 nm single-split cubes, respectively. With E-field drive, the electric dipole resonance at 38.97 and 39.47 THz and the magnetic quadrupole resonance at 43.47 and 43.72 THz are observed for the 100 and 200 nm single-split cubes, respectively. These resonances are explicitly marked in FIG. 7(b). For the 200 nm single-split cube of FIG. 7(b), the introduction of the 200 nm gap raises the frequency of the magnetic dipole resonance to overlap that of the electric dipole resonance (the resonator size is about ⅕th of the free-space wavelength at the magnetic resonance). In contrast, the frequencies of the electric dipole and magnetic quadrupole resonances are largely unaffected by the introduction of the split. Once again, the multipole decomposition accurately recovers all the spectral, angular, and phase characteristics of the scattered fields (not shown). Table 2 summarizes the power radiated by each of the dominant multipoles. The powers radiated by multipoles not listed in Table 2 were smaller by at least two orders of magnitude. Note that both quadrupolar and electric dipolar behaviors were observed at the magnetic quadrupole resonance.

TABLE 2
Powers radiated by the dominant multipoles for a subwavelength
single-split dielectric cube (s = 200 nm and d = 1.53 μm).

| | Frequency (THz) | | |
|---|---|---|---|
| | 38.97 | 39.47 | 43.72 |
| Excitation scheme | H-field drive | E-field drive | E-field drive |
| Multipole | m_{MD}^{y} | p_{ED}^{x} | p_{ED}^{x}, Q_{MQ}^{zy} |
| Power (×10⁻¹³ W) | 1.36 | 1.29 | 0.066, 0.03 |

The introduction of splits decreases the symmetry of the cubes and it becomes convenient to describe the dipole moments in terms of electric and magnetic dipole polarizability tensors defined through:

p=αₑₑ·E_{loc}, m=αₘₘ·H_{loc} (9)

where αₑₑ and αₘₘ are the electric and magnetic dipole polarizability tensors and E_{loc} and H_{loc} are the local electric and magnetic fields acting on the resonator. See A. Alu and N. Engheta, J. Appl. Phys. 97(9), 094310 (2005). For isotropic resonators, the polarizability tensors will be diagonal with equal components. The polarizability tensor of the split cubes will be diagonal in this scattering geometry, however some components will be different from each other. For this reason, only the transverse components are shown in the following, here marked simply as αₑₑ and αₘₘ.

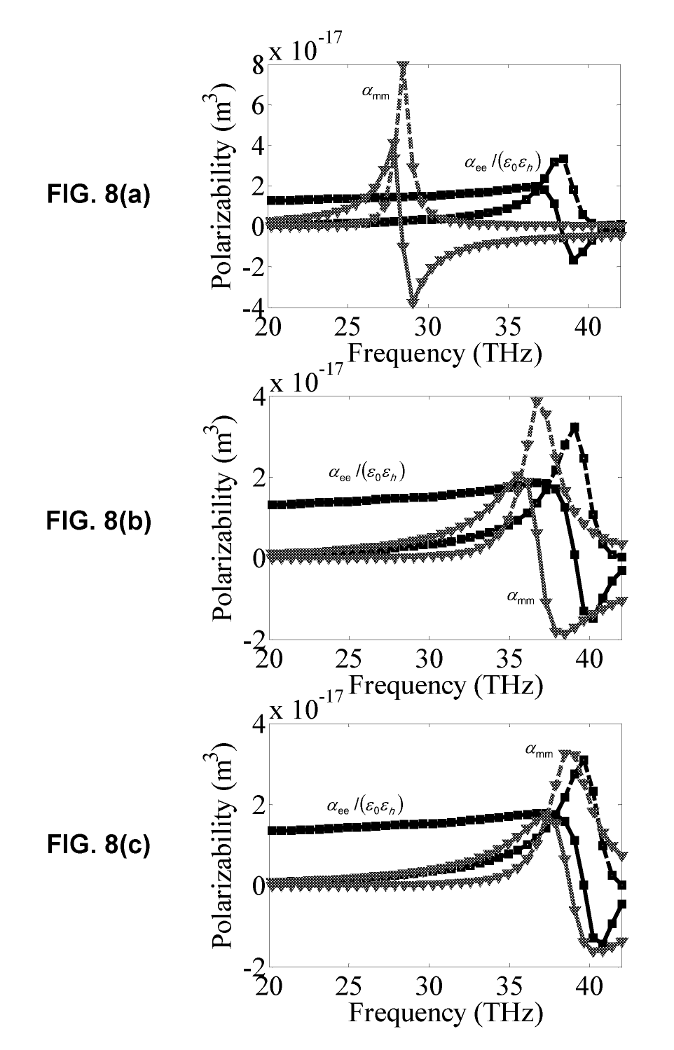

By following the multipolar decomposition procedure described above, the electric and magnetic dipole polarizabilities of full cubes and single-split cubes can be estimated. FIGS. 8(a)-(c) show the results of the decomposition procedure for a full cube as well as single-split cubes with two different gap widths. Note that this figure presents polarizabilities in units of m³, i.e. the electric polarizability in Eq. (9) is normalized to the host absolute permittivity ε₀εₕ. For the full cube, a magnetic dipole resonance around 28.31 THz (under H-field drive) followed by an electric dipole resonance at about 38.37 THz (under E-field drive) is observed, in agreement with the results described above The simulation results of FIGS. 8(b)-(c) are also in agreement with the results shown in FIGS. 7(a)-(b), and show that the introduction of the split causes the magnetic resonance to move toward higher frequencies (triangles), while leaving the electric resonance frequency unaffected (squares). For the 200 nm single-split cube of FIG. 8(c), the magnetic dipole resonance (38.97 THz) is nearly overlapped with the electric dipole resonance (39.47 THz).

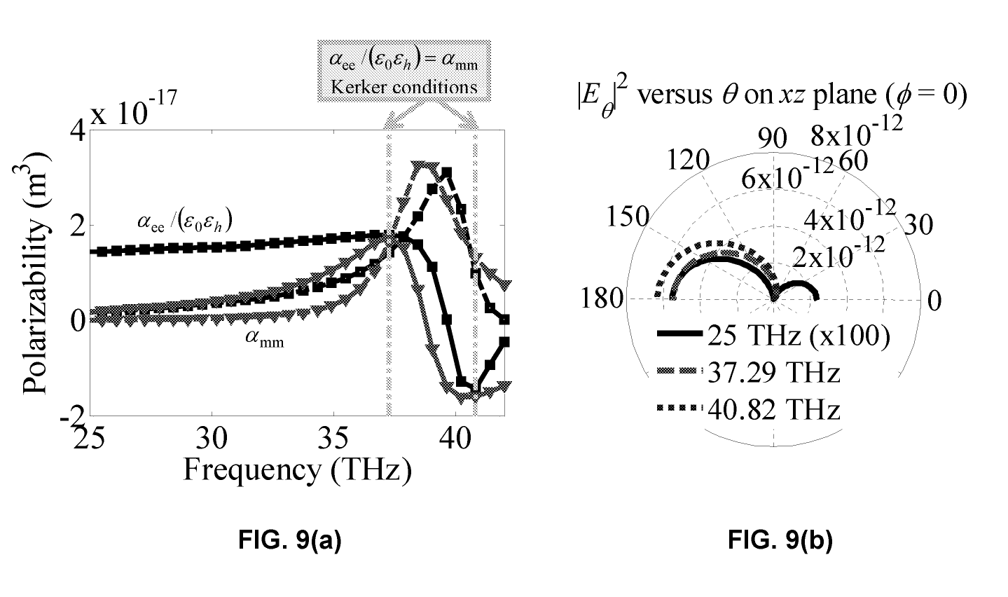

Directional forward or backward scattering for isolated resonators can be obtained by appropriately overlapping electric and magnetic resonances. See M. Kerker et al., J. Opt. Soc. Am. 73(6), 765 (1983); J. M. Geffrin et al. Nat Commun 3, 1171 (2012); and Y. H. Fu et al., Nat Commun 4, 1527 (2013). In particular, the first Kerker condition states that the isolated resonator will predominantly scatter light in the forward direction when the Mie electric and magnetic dipole coefficients are equal (a₁=b₁) and significantly larger than any higher order Mie terms aₙ, bₙ:n>1. These conditions can be equivalently expressed through the electric and magnetic dipole polarizabilities as αₑₑ/(ε₀εₕ)=αₘₘ, since αₑₑ/(ε₀εₕ)=6πia₁/k³ and αₘₘ=6πib₁/k³. Interestingly, it can be observed in FIG. 9(a) that this condition is (almost perfectly) satisfied for both real and imaginary components near 37.29 and 40.82 THz (indicated by the vertical dashed-dotted lines). FIG. 9(b) shows the scattered radiation pattern of an isolated single-split dielectric cube resonator (gap of 200 nm) excited through plane wave incidence for three excitation frequencies: 25, 37.29, and 40.82 THz. As expected, a single-lobed radiation pattern—a signature of forward scattering—is obtained at the two frequencies that satisfy the Kerker condition (37.29 and 40.82 THz). In contrast, a weaker, two-lobed scattering pattern is observed at the nonresonant frequency of 25 THz for which the Kerker condition is not satisfied. It may be possible to satisfy the Kerker conditions over a frequency band, rather than at isolated frequencies, by further tailoring the resonator design to better overlap the spectral position, width, and amplitude of the two polarizabilities.

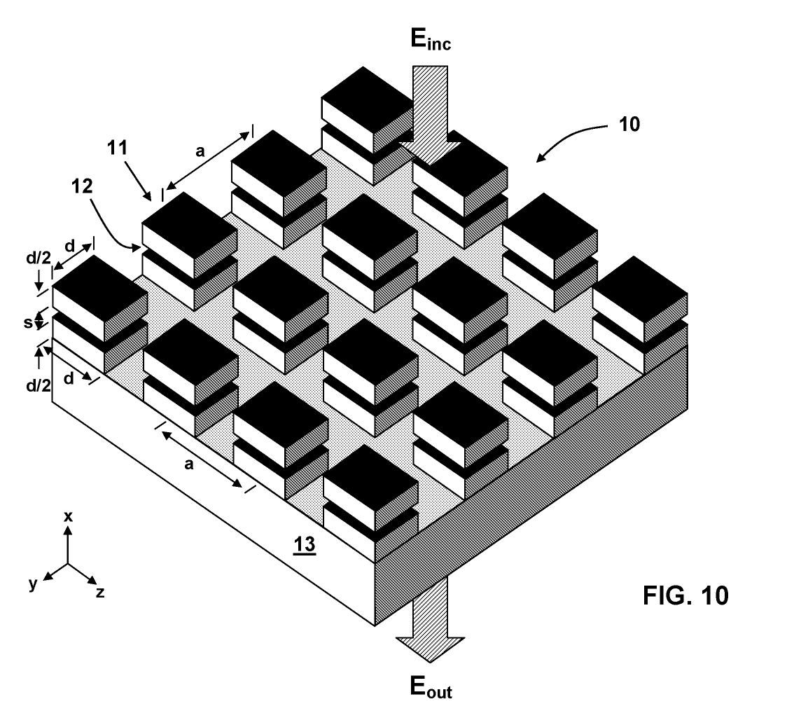

The description above has focused on the multipolar characteristics of isolated dielectric resonators. To assess the applicability of these resonator geometries to metasurfaces, consider a two-dimensional array 10 of split-cube resonators 11 arranged on a square lattice, as shown in FIG. 10. In this example, dielectric cube has sides of length d and a single split with a gap of s. The square lattice has a period a. The period is subwavelength to the incident light, which preferably has a wavelength in the microwave, visible or near-infrared spectral range. The resonators 11 preferably comprise a high-permittivity dielectric material (e.g., preferably with a refractive index greater than 3). In the case of microwave frequencies, many low loss, high permittivity dielectric materials can be used, including ZrₓSn₁₋ₓTiO₄. If infrared or visible frequencies are of interest, Si, GaAs, Ge, PbTe or Te or any other high refractive index material can be used, for example. In general, the low-permittivity inclusion 12 can be an air split, gas-filled gap, vacuum gap, or a dielectric foam. The low-permittivity inclusion can be oriented perpendicular to the electric field associated with the first magnetic mode. The array can be disposed on a low-index substrate 13, such as barium fluoride. As will be described below and by Warne et al., other perturbed resonator geometries and other lattice patterns can also be used. The two-dimensional array can provide a reflectionless Huygens' metasurface, provided the subwavelength resonators have electrically overlapping electric and magnetic dipole resonances of equal strength. Such Huygens' metasurfaces can provide engineerable wave-front control, enabling beam steering, beam shaping, focusing, and other applications.

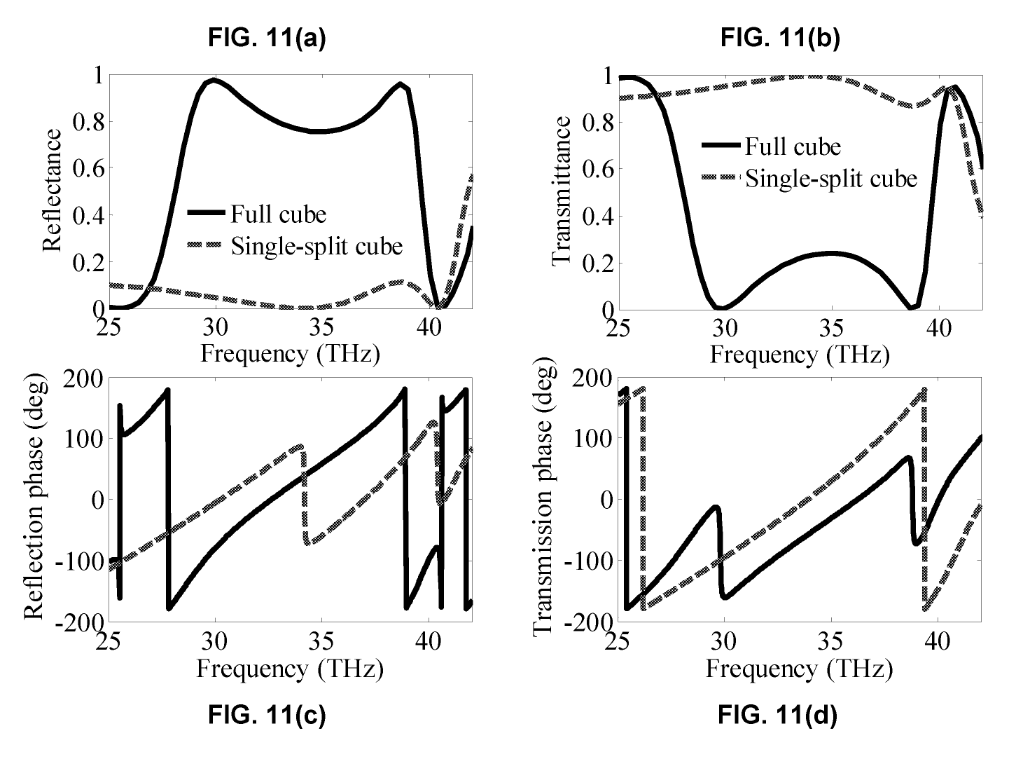

Consider, for example, a square lattice with a period of 2.6 μm. The reflectance and transmittance under normal plane wave incidence for the resonator geometries of FIG. 8(a) (full cube) and FIG. 8(c) (single-split cube with 200 nm gap) are shown in FIGS. 11(a)-(b). Fundamental differences are observed between the spectra obtained for the two geometries. The array of full dielectric cubes (which possess electric and magnetic dipole resonances in separate frequencies) exhibits two strong reflection maxima and two corresponding transmission minima. In contrast, the array of split-cubes is highly transmissive over a wide frequency band because of the near overlap of dipolar resonances as shown in FIG. 8(c) and FIG. 9(a). These results are in accord with those shown by I Staude et al. for an array of silicon nanocylinders. See I. Staude et al., ACS Nano 7(9), 7824 (2013). The phases of the reflection and transmission coefficients at a distance of 8 pm from the array plane are shown in FIGS. 11(c)-(d) for the two resonator geometries. In agreement with M. Decker et al., the transmission coefficient for the full cube metamaterial undergoes a phase shift of at most 180 degrees at each resonance, while the transmission coefficient for the split-cube metamaterial undergoes a complete 360 degree phase shift. See M. Decker et al., “High efficiency light-wave control with all-dielectric optical Huygens' metasurfaces,” arXiv:1405.5038 (2014). This combination of features—high transmittance and 360 degree phase shift—renders the split-cube metamaterial design appealing for use in Huygens' metasurfaces which are a promising platform for the development of flat optical devices. See N. Yu et al., Science 334(6054), 333 (2011); and X. Ni et al., Science 335(6067), 427 (2012). The reflection behavior is opposite that of the transmission: high reflectivity across a broad spectral range and a full 360 degree phase shift are only obtained for the full cube metamaterial. Thus, the full cube metamaterial allows manipulation of the reflection response to enable a metareflector that can be very easily fabricated. These profound differences between the behaviors of the two metamaterials demonstrate the dramatic impact that perturbations at the single resonator level can have on the metamaterial performance at the macroscopic level.

### Pushing the Quadrupolar Resonance Away from the Overlapping Electric and Magnetic Dipole Resonances with a Four-Split Dielectric Cube

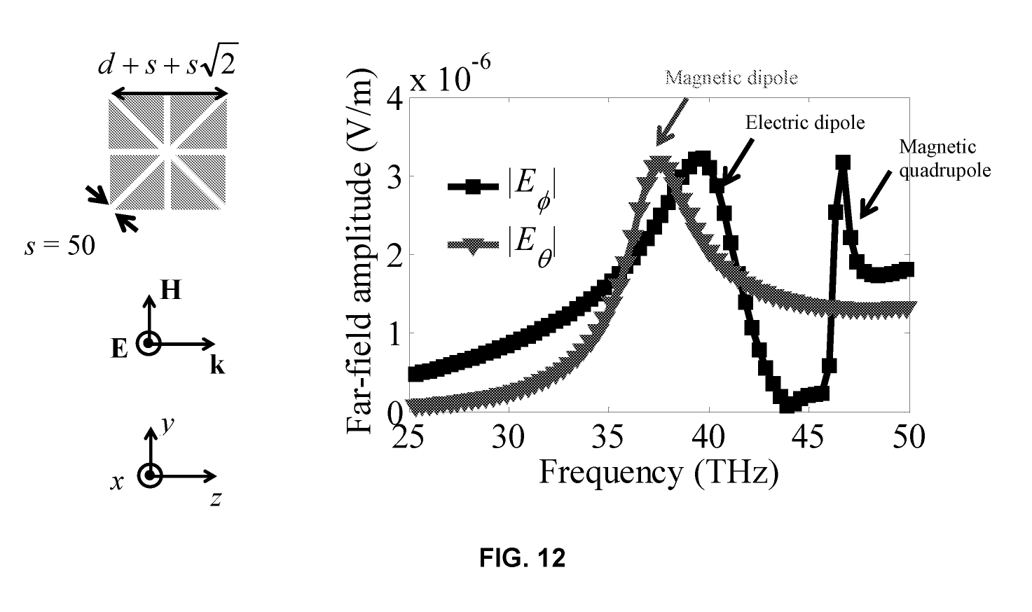

The dielectric cube resonator shown in the inset of FIG. 12 and further described by Warne et al. includes four-splits of width s=50 nm and an overall width of d+s+s\sqrt{2} (the resonator is about ⅕th of the free-space wavelength at the magnetic resonance) was analyzed. Following the same procedure used to retrieve FIG. 4, under H-field drive this resonator exhibits a magnetic dipole resonance at 37.59 THz. Under E-field drive an electric dipole resonance at 39.34 THz and a magnetic quadrupole resonance at 46.69 THz are observed, as shown in FIG. 12. Once again, the multipole decomposition accurately recovers all the spectral, angular, and phase characteristics of the scattered far fields (not shown). Table 3 summarizes the power radiated by each of the dominant multipoles. Thus, in addition to nearly overlapping the electric and magnetic dipole resonances, the use of multiple splits pushes the quadrupolar resonance to higher frequency, enabling the development of local metamaterial properties.

TABLE 3
Powers radiated by the dominant multipoles for a subwavelength four-
split dielectric cube (s = 50 nm and d = 1.53 μm).

| | Frequency (THz) | | |
|---|---|---|---|
| | 37.59 | 39.34 | 46.69 |
| Excitation scheme | H-field drive | E-field drive | E-field drive |
| Multipole | m_{MD}^{y} | p_{ED}^{x} | p_{ED}^{x}, Q_{MQ}^{zy} |
| Power (×10⁻¹³ W) | 1.38 | 1.18 | 0.11, 0.35 |

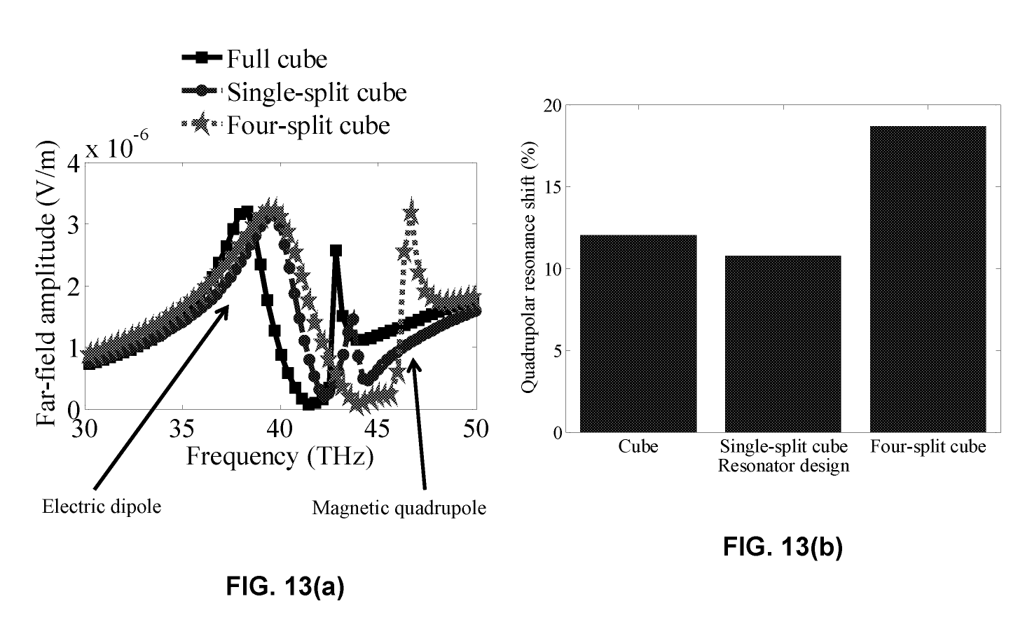

The examples above highlight the ability to use perturbation theory to obtain resonator geometries that selectively adjust the spectral locations of the resonances to achieve desired metamaterial properties including local behavior. See L. K. Warne et al., IEEE Trans. Antenn. Propag. 61(4), 2130 (2013); L. K. Warne et al., Prog. Electromagn. Res. B 44, 1 (2012); and U.S. application Ser. No. 13/618,997 to Warne et al. Single or multiple thin splits have been used to overlap the magnetic and electric dipole resonances by upshifting the frequency of the magnetic dipole to that of the electric dipole. The use of multiple splits also has the further advantage of moving the quadrupole resonance away from the dipole resonances (which has the potential of lowering losses and enabling local behavior for metamaterial applications). To better visualize this property, the percentage quadrupolar resonance shift is defined as

$$Quadrupolar resonance shift ( \% ) = \frac{{f}_{Q} - {f}_{D}}{{f}_{D}} \times 100 \qquad ( 10 )$$

where f_{Q} is the frequency of the quadrupole resonance, and f_{D} is the frequency of the closest dipole resonance. The frequency location of the quadrupolar resonance is shown in FIG. 13(a), and the quadrupolar resonance shift given by Eq. (10) is shown as a bar diagram in FIG. 13(b) for the three resonator shapes analyzed [note again that the three designs have almost equal electric dipole resonance frequency location, as can be observed in FIG. 13(a)]. It is evident that the four-split cube design has nearly doubled the quadrupolar resonance shift with respect to the single-split cube design, while keeping electric and magnetic dipolar resonances in the same spectral region.

Alternatively, one could realize a frequency downshift of the electric dipole resonance toward the magnetic dipole resonance by embedding a high-permittivity metallic dipole, oriented along the direction of the incident electric field, within the dielectric resonator. See L. K. Warne et al., IEEE Trans. Antenn. Propag. 61(4), 2130 (2013); L. K. Warne et al., Prog. Electromagn. Res. B 44, 1 (2012); and U.S. application Ser. No. 13/618,997 to Warne et al. For example, the metallic dipole can have an elongated shape, such as a rod or prolate spheroid. This approach could however increase the losses and be counterproductive if employed at infrared or higher frequencies.

In these two alternative approaches, only one perturbation type was employed to selectively frequency shift one resonance while leaving the other unperturbed. It is natural to conclude that these approaches can be combined to enable operation away from the resonant peaks to overcome frequency up/downshift saturation, to allow smaller individual inclusions to be used, and to make the resonator design somewhat invariant with respect to incident plane-wave angle. For example, if minimizing the size of the perturbations is of interest, perturbations can be combined so as to simultaneously frequency shift the magnetic and electric dipole resonances toward each other and ultimately realize overlap at some intermediate frequency with respect to the fundamental ones. See L. K. Warne et al., IEEE Trans. Antenn. Propag. 61(4), 2130 (2013); L. K. Warne et al., Prog. Electromagn. Res. B 44, 1 (2012); and U.S. application Ser. No. 13/618,997 to Warne et al. Advantages of the dual-perturbation design include the possibility of achieving resonator electrical sizes smaller than the single-split design, as well as the circumvention of frequency up/downshift saturation effects.

The design methodology described above affords great flexibility for tailoring the properties of dielectric resonators while also maintaining the subwavelength geometries required for local metamaterial properties. In particular, perturbation theory can be applied to dielectric resonators to control the spectral overlap of electric and magnetic dipole resonances, as well as the location of higher-order modes. Multipolar expansion can be used to confirm such properties and show that perturbation theory is a viable route to achieve purely dipole resonances in relatively wide frequency bands useful for the development of metamaterial applications.

The present invention has been described as a flat optics enabled by dielectric metamaterials. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A metasurface, comprising a two-dimensional periodic array of single-resonator unit cells, each resonator comprising at least one inclusion in a dielectric structure wherein the at least one inclusion has a different permittivity than the dielectric structure material and wherein the electric dipole resonance and the magnetic dipole resonance of the resonator satisfy the first Kerker condition.

2. The metasurface of claim 1, wherein the dielectric structure comprises a cubic, cylindrical, rectangular, or spherical structure.

3. The metasurface of claim 1, wherein the dielectric structure material comprises a high permittivity material.

4. The metasurface of claim 3, wherein the high permittivity material comprises ZrₓSn₁₋ₓTiO₄.

5. The metasurface of claim 3, wherein the high permittivity material comprises Si, GaAs, Ge, PbTe or Te.

6. The metasurface of claim 1, wherein the at least one inclusion comprises a low-permittivity inclusion, thereby shifting the lower frequency magnetic dipole resonance toward the higher frequency electric dipole resonance.

7. The metasurface of claim 6, wherein the low-permittivity inclusion comprises an air split, gas-filled gap, vacuum gap, or a dielectric foam.

8. The metasurface of claim 6, wherein the low-permittivity inclusion has a thin, pancake-like shape.

9. The metasurface of claim 8, wherein the thin, pancake-like shape comprises a cut plane or oblate spheroid.

10. The metasurface of claim 6, wherein the low-permittivity inclusion is oriented perpendicular to the electric field associated with the first magnetic mode.

11. The metasurface of claim 6, wherein the at least one low-permittivity inclusion comprises two or more cut planes placed rotationally about the incident electric field axis and at symmetry angles of the resonator.

12. The metasurface of claim 1, wherein the at least one inclusion comprises a metallic dipole, thereby shifting the electric dipole resonance toward the lower frequency magnetic dipole resonance.

13. The metasurface of claim 12, wherein the metallic dipole has an elongated shape.

14. The metasurface of claim 13, wherein the elongated shape comprises a rod or prolate spheroid.

15. The metasurface of claim 12, wherein the metallic dipole is oriented parallel to the direction of the incident electric field.

16. The metasurface of claim 1, wherein the at least one inclusion comprises at least one high-permittivity inclusion, thereby shifting the higher frequency electric dipole resonance to a lower frequency, and at least one low-permittivity inclusion, thereby shifting the lower frequency magnetic dipole resonance to a higher frequency.
